(19) United States
(12) Patent Application Publication
(10) Pub. No.: US 2024/0024747 A1
(43) Pub. Date: Jan. 25, 2024

(54) Hockey Blade Sleeve Device

(71) Applicant: Michael Rubino, NDIP (CA)

(72) Inventor: Michael Rubino, NDIP (CA)

(21) Appl. No.: 17/867,794

(22) Filed: Jul. 19, 2022

(51) Int. Cl. A63B 60/56; B29C 63/18

(52) U.S. Cl. CPC A63B 60/56; B29C 63/18; A63B 2102/24

(57) ABSTRACT

A hockey blade sleeve device for being secured to and removable from the blade of a hockey stick includes a sleeve positioned on the foot of a hockey stick when playing a game of hockey. The sleeve has an exterior surface and an interior surface. The exterior surface is a cloth material, and the interior surface is an elastic material. An opening of the sleeve is positioned on a first end of the sleeve. The opening is positioned proximate to an end of the foot of the hockey stick. A tip of the sleeve is positioned on a second end of the sleeve. The tip is positioned on a toe of the foot of the hockey stick.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

The disclosure relates to hockey blade cover device and more particularly pertains to a new hockey blade cover device for being secured to and removable from the blade of a hockey stick.

### (2) Description of Related Art Including Information Disclosed Under 37 CFR 1.97 and 1.98.

The prior art relates to hockey blade cover devices. Known prior art includes a variety of hockey blade cover devices that secure to the blade of a hockey stick by a long lasting adhesive. Furthermore, the prior art relates to a variety of hockey blade cover devices that cover the blade of the hockey stick with a sleeve. Known prior art lacks a hockey blade cover device having a cloth material configured for securing to the blade of the hockey stick by an adhesive and compression from an elastic material for use during a hockey game and being removable.

### BRIEF SUMMARY OF THE INVENTION

An embodiment of the disclosure meets the needs presented above by generally comprising a sleeve configured for being positioned on the foot of a hockey stick when playing a game of hockey. The sleeve has an exterior surface and an interior surface. The exterior surface is a cloth material, and the interior surface is an elastic material. An opening of the sleeve is positioned on a first end of the sleeve. The opening is configured for being positioned proximate to an end of the foot of the hockey stick. A tip of the sleeve is positioned on a second end of the sleeve. The tip is configured for being positioned on a toe of the foot of the hockey stick.

Furthermore, a method for enwrapping a sleeve around a foot of a hockey stick includes the step of inserting an opening of a sleeve onto a toe of the foot of the hockey stick. The opening of the sleeve is an elastic material configured for expanding around the foot of the hockey stick. The user pulls the opening of the sleeve towards an end of the foot of the hockey stick. A cavity of the sleeve enwraps the foot of the hockey stick. The user positions a tip of the sleeve adjacent to the toe of the foot of the hockey stick. Subsequently, the user removes the sleeve from the foot of the hockey stick if the sleeve is damaged and needs to be replaced.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a hockey blade sleeve device according to an embodiment of the disclosure.

FIG. 2 is a bottom isometric view of an exploded embodiment of the disclosure.

FIG. 3 is a front view of an in-use embodiment of the disclosure.

FIG. 4 is a front view of an alternate embodiment of the disclosure.

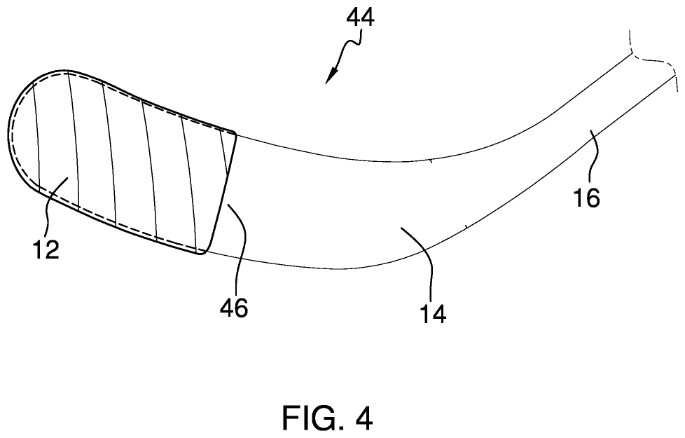

FIG. 5 is a front view of an embodiment of the disclosure.

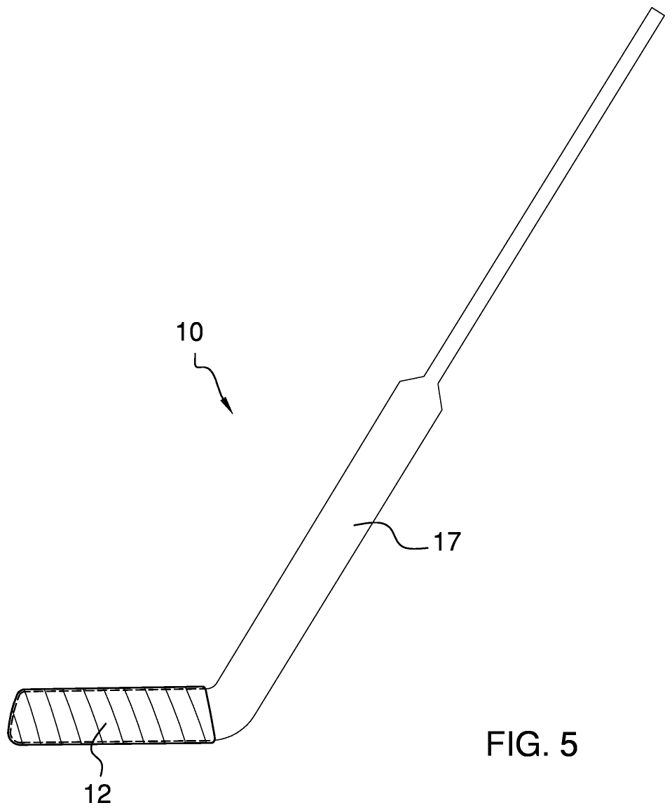

### DETAILED DESCRIPTION OF THE INVENTION

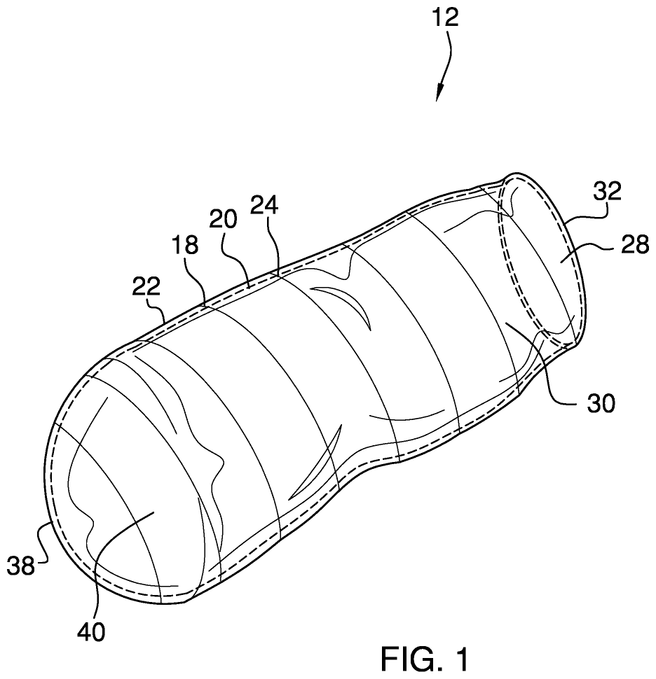

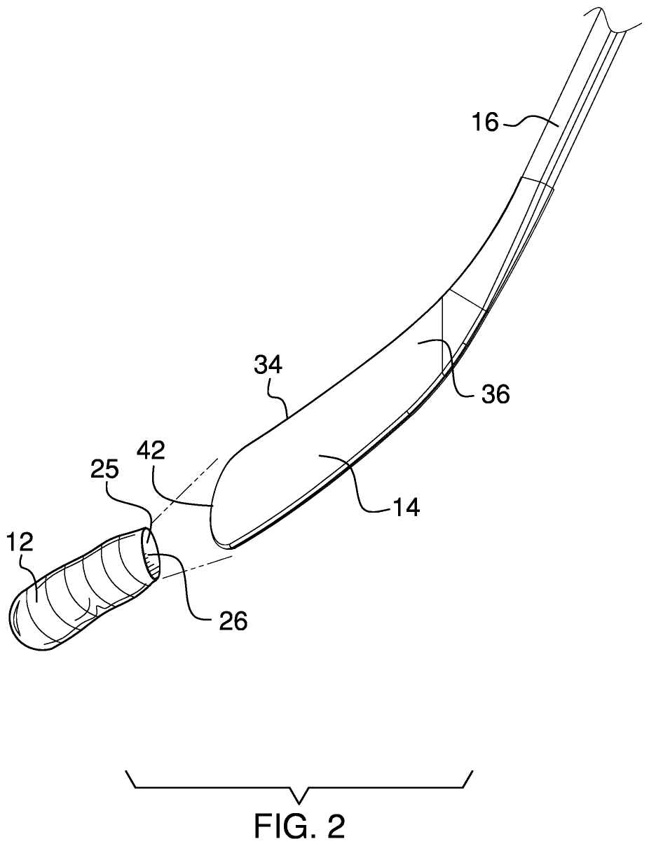

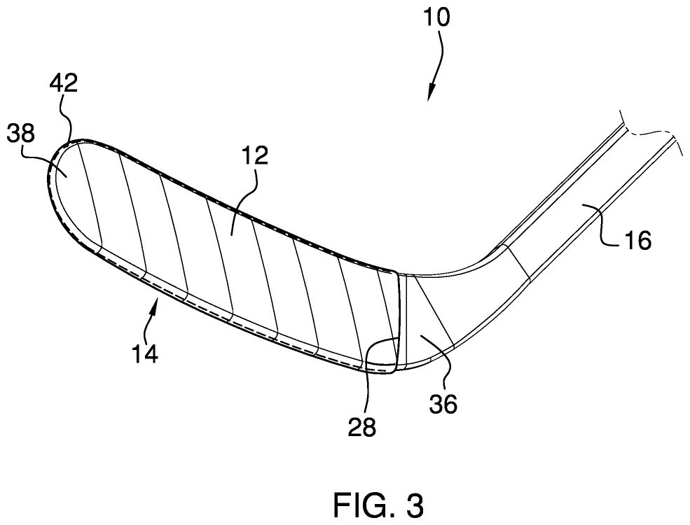

With reference now to the drawings, and in particular to FIGS. 1 through 3 thereof, a new hockey blade cover device embodying the principles and concepts of an embodiment of the disclosure and generally designated by the reference numeral 10 will be described.

As best illustrated in FIGS. 1 through 3, the hockey blade sleeve device 10 generally comprises a sleeve 12. The sleeve 12 is configured for being positioned on the foot 14 of a hockey stick 16 when playing a game of hockey. The sleeve 12 has an exterior surface 18 and an interior surface 20. The exterior surface 18 is a cloth material 22 being a felted fabric. The cloth material 22 is liquid resistant and is configured for protecting the foot 14 of the hockey stick 16 from moisture and impact damages. The cloth material 22 allows the foot 14 of the hockey 16 stick to glide along the ice during a hockey game without damaging the hockey stick 16 due to the water condensation of the ice. Furthermore, the cloth material 22 protects the hockey stick 16 from impact damages from the hockey puck.

The interior surface 20 of the sleeve 12 is an elastic material 24 configured for stretching. The elastic material 24 has an adhesive 25 being configured for adhering to the foot 14 of the hockey stick 16. The sleeve 12 has a cavity 26 defining a space for the foot 14 of the hockey stick 16 to be nested within. The size of the sleeve 12 is configured for being small-scaled relative to the foot 14 of the hockey stick 16 prior to securing the sleeve 12 to the hockey stick 16. The elastic material 24 of the interior surface 20 is configured for retaining to the foot 14 of the hockey stick 16 by compression and friction from the adhesive 25. Additionally, the sleeve 12 is removable from the foot 14 of the hockey stick 16 by pulling the sleeve 12 off from the foot 14 of the hockey stick 16. The sleeve 12 is configured for fitting a range of sizes for the foot 14 of the hockey stick 16 including fitting the foot 14 of a goalie hockey stick 17.

An opening 28 of the sleeve 12 is positioned on a first end 30 of the sleeve 12. The opening 28 is a circular aperture providing access to the cavity 26 of the sleeve 12. The opening 28 has a perimeter 32 being the elastic material 24. The perimeter 32 of the opening 28 is configured for being small-scaled relative to the perimeter 34 of the foot 14 of the hockey stick 16 prior to securing the sleeve 12 to the hockey stick 16. The opening 28 is configured for expanding as the sleeve 12 is secured to the hockey stick 16. The opening 28 is configured for being positioned proximate to an end 36 of the foot 14 of the hockey stick 16. Furthermore, an alternate embodiment 44 includes the opening 28 being positioned in a center 46 of the foot 14 of the hockey stick 16 to provide partial protection to the foot 14 of the hockey stick 16.

A tip 38 of the sleeve 12 is positioned on a second end 40 of the sleeve 12. The tip 38 seals the second end 40 of the sleeve 12 wherein enclosing the cavity 26 of the sleeve 12. The tip 38 is configured for being positioned on a toe 42 of the foot 14 of the hockey stick 16. The tip 38 of the sleeve 12 provides entire coverage around the toe 42 of the foot 14 of the hockey stick 16 wherein protecting the toe 42 of the foot 14 of the hockey stick 16.

In use, the opening 28 of the sleeve 12 is inserted onto the toe 42 of the foot 14 of the hockey stick 16. The opening 28 of the sleeve 12 expands around the foot 14 of the hockey stick 16 as the user pulls the opening 28 of the sleeve 12 towards the end 36 of the foot 14 of the hockey stick 16. The cavity 26 of the sleeve 12 enwraps the foot 14 of the hockey stick 16 and fastens to the hockey stick 16 from friction and compression of the elastic material 24 of the interior surface 20 of the sleeve 12. The tip 38 of the sleeve 12 becomes adjacent to the toe 42 of the foot 14 of the hockey stick 16 as the sleeve 12 is finished securing to the hockey stick 16. The user can play a game of hockey with the sleeve 12 secured to the foot 14 of the hockey stick 16. Subsequent to the game of hockey, the user can remove the sleeve 12 from the foot 14 of the hockey stick 16 by pulling the sleeve 12 off of the hockey stick 16 only if the sleeve 12 is damaged and needs to be replaced.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A hockey stick sleeve device configured for protecting the foot of the hockey stick, the device comprising:
a sleeve being configured for being positioned on the foot of a hockey stick when playing a game of hockey, the sleeve having an exterior surface and an interior surface, the exterior surface being a cloth material, the interior surface being an elastic material;
an opening of the sleeve being positioned on a first end of the sleeve, the opening being configured for being positioned proximate to an end of the foot of the hockey stick; and
a tip of the sleeve being positioned on a second end of the sleeve, the tip being configured for being positioned on a toe of the foot of the hockey stick.

2. The hockey stick sleeve device of claim 1, further comprising the cloth material being a felted fabric.

3. The hockey stick sleeve device of claim 2, further comprising the cloth material being liquid resistant, the cloth material being configured for protecting the foot of the hockey stick from moisture and impact damages.

4. The hockey stick sleeve device of claim 1, further the elastic material being configured for stretching, the elastic material having an adhesive, the adhesive being configured for adhering to the foot of the hockey stick.

5. The hockey stick sleeve device of claim 1, further comprising the sleeve having a cavity, the cavity defining a space for the foot of the hockey stick to be nested within.

6. The hockey stick sleeve device of claim 5, further comprising the elastic material of the interior surface being configured for retaining to the foot of the hockey stick by compression and friction from the adhesive.

7. The hockey stick sleeve device of claim 6, further comprising the sleeve being removable from the foot of the hockey stick.

8. The hockey stick sleeve device of claim 1, further comprising the sleeve being configured for fitting a range of sizes for the foot of the hockey stick.

9. The hockey stick sleeve device of claim 8, further comprising the opening being a circular aperture.

10. The hockey stick sleeve device of claim 9, further comprising the opening providing access to the cavity of the sleeve.

11. The hockey stick sleeve device of claim 10, further comprising the opening having a perimeter, the perimeter being the elastic material, the opening being configured for expanding.

12. The hockey stick sleeve device of claim 11, further comprising an alternate embodiment including the opening being positioned in a center of the foot of the hockey stick.

13. The hockey stick sleeve device of claim 12, further comprising the tip sealing the second end of the sleeve wherein enclosing the cavity of the sleeve.

14. A hockey stick sleeve device configured for protecting the foot of the hockey stick, the device comprising:
a sleeve being configured for being positioned on the foot of a hockey stick when playing a game of hockey, the sleeve having an exterior surface and an interior surface, the exterior surface being a cloth material, the cloth material being a felted fabric, the cloth material being liquid resistant, the cloth material being configured for protecting the foot of the hockey stick from moisture and impact damages, the interior surface being an elastic material, the elastic material being configured for stretching, the elastic material having an adhesive, the adhesive being configured for adhering to the foot of the hockey stick, the sleeve having a cavity, the cavity defining a space for the foot of the hockey stick to be nested within, the elastic material of the interior surface being configured for retaining to the foot of the hockey stick by compression and friction from the adhesive, the sleeve being removable from the foot of the hockey stick, the sleeve being configured for fitting a range of sizes for the foot of the hockey stick;
an opening of the sleeve being positioned on a first end of the sleeve, the opening being a circular aperture, the opening providing access to the cavity of the sleeve, the opening having a perimeter, the perimeter being the elastic material, the opening being configured for expanding, the opening being configured for being positioned proximate to an end of the foot of the hockey stick, an alternate embodiment including the opening being positioned in a center of the foot of the hockey stick; and
a tip of the sleeve being positioned on a second end of the sleeve, the tip sealing the second end of the sleeve wherein enclosing the cavity of the sleeve, the tip being configured for being positioned on a toe of the foot of the hockey stick.

15. A method for enwrapping a sleeve around a foot of a hockey stick, the method including the step of:
inserting an opening of a sleeve onto a toe of the foot of the hockey stick, the opening of the sleeve being an elastic material configured for expanding around the foot of the hockey stick;
pulling the opening of the sleeve towards an end of the foot of the hockey stick, a cavity of the sleeve enwrapping the foot of the hockey stick;
positioning a tip of the sleeve adjacent to the toe of the foot of the hockey stick; and
removing the sleeve from the foot of the hockey stick after using the hockey stick if the sleeve being damaged and needing to be replaced.
